(19) United States
(12) Patent Application Publication
(10) Pub. No.: US 2011/0247378 A1
(43) Pub. Date: Oct. 13, 2011

(54) Low-Carbon Fertilizers and Processes for Producing the Same

(76) Inventors: Paul V. Begley, Lakewood, CO (US); J. Scott Dyer, Lakewood, CO (US); Louis R. Gervasi, Lakewood, CO (US); James W. Muzzy, Lakewood, CO (US)

(21) Appl. No.: 12/944,139

(22) Filed: Nov. 11, 2010

Related U.S. Application Data
(60) Provisional application No. 61/261,150, filed on Nov. 13, 2009.

(51) Int. Cl. C05F 11/00; C05F 11/08; C05F 9/00; C05F 1/00; C05C 9/00; C05F 3/00; C05F 11/02

(52) U.S. Cl. 71/8; 71/11; 71/21; 71/23; 71/6; 71/24; 71/16; 71/28; 71/14

(57) ABSTRACT

Novel low-carbon fertilizers and processes useful for the production of the novel low-carbon fertilizers are disclosed.

### CROSS-REFERENCE TO RELATED APPLICATION

The present application claims the benefit under 35 U.S.C. §119(e) to U.S. Provisional Patent Application No. 61/261,150, which was filed on Nov. 13, 2009, and entitled “LOW-CARBON FERTILIZERS AND PROCESSES FOR PRODUCING THE SAME,” which is incorporated by reference into the present application in its entirety.

### FIELD

The disclosure relates to novel, low-carbon fertilizers and processes useful for the production of the novel, low-carbon fertilizers.

### BACKGROUND

It is well known that organic waste can be used for soil enhancement and plant nutrition. The organic waste that is typically used for these purposes can be used in its native state, or it can be enhanced during production to include various nutrients and/or chemicals suitable for a variety of purposes. Traditional production processes attempt to enhance the organic waste in a variety of ways. Many processes produce products that are often quite highly processed before use, in order to provide additional nutrients and/or to accelerate their reactions. This has often resulted in products that contain large quantities of nitrogenous materials, phosphates and potassium such that the products themselves become an environmental liability. For example, many known, commercially available fertilizer products use large quantities of synthetic, or man-made, nitrogen sources such as ammonia. The nitrogen sources are often synthesized using the Haber-Bosch process, which produces ammonia. Ammonia may then be used to produce other compounds, such as anhydrous ammonium nitrate and urea. The production of ammonia in this manner consumes a large percentage of global natural gas consumption (presently estimated at about 5%). The production of these nitrogen sources produces large amounts of industrial by-products, including greenhouse gases. Additionally, upon application to the soil, many of the known, commercially available fertilizers leech nitrogen phosphorus and/or potassium into the soils in high amounts, where they are freely passed into a water supply or they evaporate into the atmosphere as a greenhouse gas. Therefore, fertilizers that use synthetic nitrogen sources typically display a large carbon footprint and can be harmful to the environment both during production and upon application to the soil. It is thus difficult to generate products using known processing methods that contain a sufficient amount of nutrients and that do not harm the environment.

There is therefore a need in the art for low-carbon fertilizers capable of being produced from bulk biomasses and/or bulk biological waste streams that are both environmentally friendly and that contain a sufficient amount of nutrients to benefit a wide variety of plants and crops. There is further a need for processes for producing low-carbon fertilizers. The present disclosure addresses these and other needs.

### SUMMARY

In various aspects, low-carbon fertilizers are disclosed. In various aspects, processed for producing low-carbon fertilizers are disclosed.

In various aspects, low-carbon fertilizers comprising an organic matter component, a biological materials component, a nutrients component, and a nitrogen source component are disclosed. In some aspects, low-carbon fertilizers comprising at least greater than 45% to less than 100% of an organic matter component; greater than 0% to less than 2% of a biological materials component; greater than 0% to less than 35% of a nutrients component; and greater than 0% to less than 30% of a nitrogen source component are disclosed.

In various aspects, low-carbon fertilizers comprising at least greater than 70% to less than 100% of an organic matter component; greater than 0% to less than 2% of a biological materials component; and greater than 0% to less than 30% of a nutrients component are disclosed.

In some embodiments, the organic matter component comprises raw manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, or combinations thereof.

In some embodiments, the organic matter component comprises raw plant matter, or other naturally occurring material such as, for example, bacteria, algae, fungi, coal, other mined material, or combinations thereof.

In some embodiments, the organic matter component comprises composted manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, or combinations thereof.

In some embodiments, the organic matter component comprises composted plant matter.

In some embodiments, the organic matter component comprises ash produced in incineration facilities. In some embodiments, the ash produced in incinerator facilities is incinerator ash. In some embodiments, the ash produced in incinerator facilities is incinerator bottom ash. In some embodiments, the ash produced in incinerator facilities is incinerator fly ash. In some embodiments, the ash produced in incinerator facilities is boiler ash. In some embodiments, the ash produced in incinerator facilities is boiler wood ash. In some embodiments, the ash produced in incinerator facilities is boiler coal ash. In some embodiments, the ash produced in incinerator facilities is boiler tire ash.

In some embodiments, the organic matter component comprises ash produced by a gasification process and/or by a process that converts carbon-based materials (e.g. coal, petroleum, biofuels, house waste, compost, biomass, etc.) into carbon monoxide and hydrogen by reacting the materials with oxygen and/or steam at high temperatures.

In some embodiments, the organic matter component comprises food waste. In some embodiments, food waste comprises any food substance, raw or cooked, which is discarded, intended to be discarded, and/or required to be discarded.

In some embodiments, the organic matter component comprises composted food waste. In some embodiments, composted food waste comprises any food substance, raw or cooked, which is discarded, intended to be discarded, and/or required to be discarded.

In some embodiments, the organic matter component comprises fish waste. In some embodiments, the fish waste comprises fish manure. In some embodiments, the fish waste comprises fish heads, bones, fins, tails, skins, and combinations thereof. In some embodiments, the fish waste comprises organs, blood vessels, fat, and other products from the fish cleaning process.

In some embodiments, the organic matter component comprises composted fish waste. In some embodiments, the composted fish waste comprises fish manure. In some embodiments, the composted fish waste comprises fish heads, bones, fins, tails, skins, and combinations thereof. In some embodiments, the composted fish waste comprises organs, blood vessels, fat, and other products from the fish cleaning process.

In some embodiments, the organic matter component comprises digestates. In some embodiments, the digestates comprise any solid material remaining after anaerobic digestion of a biodegradable feedstock. In some embodiments, the digestates are acidogenic digestates. In some embodiments, the digestates are methanogenic digestates.

In some embodiments, the biological matter component comprises diazotrophs, cyanobacteria, azotobacteraceae, rhizobia, frankia, azospirillum, Klebsiella pneumoniae, Azotobacter vinlandii, Desulfovibrio, Bacillus polymyxa, Bacillus macerans, Escherichia intermedia, Anabaena cylindrica, Nostoc commune, Plectonema, Rhodobacter sphaeroides, Rhodopseudomonas palustris, Rhodobacter capsulatus, or combinations thereof, and others considered beneficial to plant health.

In some embodiments, the nutrients component comprises phosphorus, potassium, calcium, magnesium, sulfur, silicon, chlorine, iron, chelated iron, boron, manganese, sodium, zinc, copper, nickel, molybdenum, selenium, aluminum, cobalt, or combinations thereof.

In some embodiments, the nitrogen source component comprises ammonia, urea, ammonium nitrate, anhydrous ammonium nitrate, urea ammonium nitrate, sodium nitrate, other mined sources of nitrogen, or combinations thereof, and others considered beneficial to plant health.

In some embodiments, the fertilizer comprises 67% composted organic matter component; 0.5% biological materials component; 0.5% nutrients component; and 32% nitrogen source component; wherein the total moisture content of the fertilizer is less than approximately 15%.

In some embodiments, the fertilizer comprises: 67% composted organic matter component; 0.5% biological materials component; 0.5% nutrients component; and 32% nitrogen source component; wherein the total moisture content of the fertilizer is approximately 17%.

In some embodiments, the fertilizer comprises: 99% composted organic matter component; 0.5% biological materials component; and 0.5% nutrients component; wherein the total moisture content of the fertilizer is less than approximately 15%.

In some embodiments, the fertilizer comprises: 99% composted organic matter component; 0.5% biological materials component; and 0.5% nutrients component; wherein the total moisture content of the fertilizer is approximately 17%.

In various aspects, processes for producing low-carbon fertilizers is disclosed, the processes comprising: processing organic matter to optimize moisture content and particle size and to remove contaminant material; adding nutrients and a nitrogen source to the organic matter; processing the organic matter to a final particle size; and adding biological materials to the organic matter to produce the low-carbon fertilizer. In some embodiments, the process also comprises packaging the low-carbon fertilizer. In some embodiments, the process also comprises storing the low-carbon fertilizer.

In some embodiments, the organic matter comprises raw manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, or combinations thereof.

In some embodiments, the organic matter comprises raw plant matter, or other naturally occurring material such as, for example, bacteria, algae, fungi, coal, other mined material, or combinations thereof.

In some embodiments, the organic matter comprises composted manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, or combinations thereof.

In some embodiments, the organic matter comprises composted plant matter.

In some embodiments, the organic matter component comprises ash produced in incineration facilities. In some embodiments, the ash produced in incinerator facilities is incinerator ash. In some embodiments, the ash produced in incinerator facilities is incinerator bottom ash. In some embodiments, the ash produced in incinerator facilities is incinerator fly ash. In some embodiments, the ash produced in incinerator facilities is boiler ash. In some embodiments, the ash produced in incinerator facilities is boiler wood ash. In some embodiments, the ash produced in incinerator facilities is boiler coal ash. In some embodiments, the ash produced in incinerator facilities is boiler tire ash.

In some embodiments, the organic matter component comprises ash produced by a gasification process and/or by a process that converts carbon-based materials (e.g. coal, petroleum, biofuels, house waste, compost, biomass, etc.) into carbon monoxide and hydrogen by reacting the materials with oxygen and/or steam at high temperatures.

In some embodiments, the organic matter component comprises food waste. In some embodiments, food waste comprises any food substance, raw or cooked, which is discarded, intended to be discarded, and/or required to be discarded.

In some embodiments, the organic matter component comprises composted food waste. In some embodiments, composted food waste comprises any food substance, raw or cooked, which is discarded, intended to be discarded, and/or required to be discarded.

In some embodiments, the organic matter component comprises fish waste. In some embodiments, the fish waste comprises fish manure. In some embodiments, the fish waste comprises fish heads, bones, fins, tails, skins, and combinations thereof. In some embodiments, the fish waste comprises organs, blood vessels, fat, and other products from the fish cleaning process.

In some embodiments, the organic matter component comprises composted fish waste. In some embodiments, the composted fish waste comprises fish manure. In some embodiments, the composted fish waste comprises fish heads, bones, fins, tails, skins, and combinations thereof. In some embodiments, the composted fish waste comprises organs, blood vessels, fat, and other products from the fish cleaning process.

In some embodiments, the organic matter component comprises digestates. In some embodiments, the digestates comprise any solid material remaining after anaerobic digestion of a biodegradable feedstock. In some embodiments, the digestates are acidogenic digestates. In some embodiments, the digestates are methanogenic digestates.

In some embodiments, the nutrients comprise phosphorus, potassium, calcium, magnesium, sulfur, silicon, chlorine, iron, chelated iron, boron, manganese, sodium, zinc, copper, nickel, molybdenum, selenium, aluminum, cobalt, and combinations thereof.

In some embodiments, the nitrogen source comprises ammonia, urea, ammonium nitrate, anhydrous ammonium nitrate, urea ammonium nitrate, sodium nitrate, other mined sources of nitrogen, or combinations thereof, and others considered beneficial to plant health.

In some embodiments, the biological materials comprise diazotrophs, cyanobacteria, azotobacteraceae, rhizobia, frankia, azospirillum, Klebsiella pneumoniae, Azotobacter vinlandii, Desulfovibrio, Bacillus polymyxa, Bacillus macerans, Escherichia intermedia, Anabaena cylindrica, Nostoc commune, Plectonema, Rhodobacter sphaeroides, Rhodopseudomonas palustris, Rhodobacter capsulatus, or combinations thereof, and others considered beneficial to plant health.

In various aspects, processes for producing low-carbon fertilizers are disclosed, the processes comprising: loading bulk organic matter into a load hopper; sizing the bulk organic matter in a single vibrating screen; adding a member of the group selected from nutrients, a nitrogen source, biological materials, and/or combinations thereof to the bulk organic matter in a batch mixer to form a mixture; passing the mixture to a feed hopper; passing the mixture to a pellet mill via a conveyor; generating pellets from the mixture in the pellet mill; cooling the pellets on a conveyor; sizing the pellets in a crumbler to create sized pellets; recovering the sized pellets in a double vibrating screen; and adding at least one biological material to the sized pellets in a conveyor to generate a low-carbon fertilizer.

In various aspects, processes for producing low-carbon fertilizers are disclosed, the processes comprising: loading bulk organic matter into a feeder; drying the organic matter in an agitated tube dryer; sizing the bulk organic matter in a single vibrating screen; adding a member of the group selected from nutrients, a nitrogen source, biological materials, and/or combinations thereof to the bulk organic matter on a conveyor to form a mixture; passing the mixture to a pellet mill; generating pellets from the mixture in the pellet mill; passing the pellets to a cooler; cooling the pellets in the cooler; sizing the pellets in a crumbler to create sized pellets; recovering the sized pellets in a double vibrating screen; and adding at least one biological material to the sized pellets in a conveyor to generate a low-carbon fertilizer.

In various aspects, the present disclosure is directed to low carbon renewable fertilizers that manage various product or ingredient streams into an end product. In some embodiments, the fertilizers are low carbon, renewable fertilizers that perform at the level of conventional products and/or synthetically based fertilizers, while minimizing the carbon footprint required for meeting plant fertility needs.

In some embodiments, the base ingredients of the fertilizers comprise: compost, various digester digestates, various ash products from incinerators and/or gasifiers, manure streams and lagoon wastes, biosolids from sewage plants, municipal green waste/yard clippings, food wastes, digestates and other sources. Each of these components have a base level of fertility. The primary function of many of the base ingredients is to supply a series of low content nutrients, trace minerals and desirable bacteria that contribute to improvements in fertility and soil structure. In various embodiments, each of the foregoing basic ingredients can have one or more of the following characteristics: excess moisture; minimal moisture; powder; variable sized grains (granular); variable composition; minimal basic nutrient content; and/or pathogens.

In various embodiments, the present disclosure is directed to the preparation of basic ingredients to ensure that the supplement nutritional and biological values are maintained and to the management and processing of process streams to optimize handling characteristics. Preparing and managing inbound streams, along with key additives and formulations, assures that the benefits of the additives and additional components, as described herein, are maintained.

In various aspects, the present disclosure is directed to processes involving material handling components to process basic ingredient streams and to incorporate additives to increase the nutrient concentration of the low-carbon fertilizers with one or more additives and/or additional components capable of delivering: an increase in nutrient utilization; an increase in nutrient content; nitrogen fixing bacteria; bacterial support mechanisms; trace mineral components to meet market requirements; absence of chemicals and toxins that are in many known fertilizers; balanced elements and colloidal elements; increases in fertility yields; and both liquid and dry fertilizer products.

In various aspects, it is the arrangement, order of addition and/or processing of the various disclosed components that make them novel in the low-carbon fertilizers.

In some embodiments, the movement of one or more fertilizer products from an undifferentiated product stream to a differentiated product stream are specific to market demand and product requirements, as well as soil conditions. In some embodiments, the conversion of products which previously had little economic value and poor handling characteristics leads to products that have higher market value by utilizing the processing and additives disclosed herein to increase handling characteristics, nutrient values, soil rebuilding attributes, and market value.

In various aspects, the present disclosure relates to determining which high value components can be added to what carrier to meet the needs of the target agriculture crop market. Understanding the impact of the component characteristics on the crop, and the location/availability of the carrier in a particular region is one aspect to the process.

In various aspects, the present disclosure relates to the sequencing of the high value components into the mechanical process to create a finished fertilizer product. This process ensures that the finished product delivers the desired fertility results to the end fertilizer product. The sequencing is necessary to deliver products that have favorable handling characteristics and to ensure proper performance of the fertilizer products. For example, adding one or more of the components disclosed herein incorrectly (e.g. in the incorrect amount and/or at the incorrect time during production) can yield a fertilizer product that may damage the plant it is applied to, the soil surrounding the plant, or both.

### BRIEF DESCRIPTION OF THE DRAWINGS

FIG. 1 depicts an exemplary process and apparatus for generating low-carbon fertilizers.

FIG. 2 depicts another exemplary process and apparatus for generating low-carbon fertilizers.

### DETAILED DESCRIPTION

Reference is now made in detail to certain embodiments of low-carbon fertilizers, and processes for producing low-carbon fertilizers. The disclosed embodiments are not intended to be limiting of the claims. To the contrary, the claims are intended to cover all alternatives, modifications, and equivalents.

### Low-Carbon Fertilizers

The present disclosure relates to low-carbon fertilizers. Low-carbon fertilizers generally refer to components applied to promote plant and fruit growth. Low-carbon fertilizers can be applied either directly to the soil, for uptake by plant roots, or by foliar feeding, for uptake through leaves. In various aspects, low-carbon fertilizers comprise one or more naturally occurring elements and/or compounds. In various aspects, low-carbon fertilizers can be used to improve the health and productivity of soil and plants by providing at least one essential nutrient to encourage plant growth. In some embodiments, low-carbon fertilizers increase the abundance of soil organisms by providing organic matter and nutrients for such organisms.

The low-carbon fertilizers can be used in any application for which conventional fertilizers are useful. The low-carbon fertilizers can thus be used in a number of applications including, without limitation, as fertilizer for crops, as fertilizer for lawns, as plant fertilizer, as micronutrient fertilizer, and as macronutrient fertilizer, among others.

In various aspects, the present disclosure is directed to low-carbon fertilizers comprising at least one of an organic matter component, a biological materials component, a nutrients component, a nitrogen source component, and combinations thereof. The relative composition of the components of the low-carbon fertilizers can vary. In various embodiments, the organic matter component is the largest component of the low-carbon fertilizers.

In some embodiments, the low-carbon fertilizers comprise an organic matter component, a biological materials component, a nutrients component and a nitrogen source component. In some embodiments, the low-carbon fertilizers comprise an organic matter component, a biological materials component and a nutrients component.

In various aspects, the low-carbon fertilizers disclosed herein are produced by processing a base of organic matter. In some aspects, the organic matter is initially processed to optimize moisture content and particle size and to remove contaminant material. In some embodiments, nutrients and a nitrogen source are added during initial processing. In some embodiments, the nitrogen-phosphorus-potassium (NPK) ratio is adjusted during initial processing. In various aspects, the optimized organic matter is processed further to a final particle size. In some embodiments, biological materials are added during further processing. In various aspects, the processed low-carbon fertilizer is then packaged and/or stored.

In various aspects, the fertilizers disclosed herein display a lower overall carbon footprint than several known, commercially prepared and available fertilizers in that the overall level of greenhouses gases produced during the production and/or use of the fertilizers is reduced. The fertilizers disclosed herein are produced from waste products that require no additional production or processing steps. In some embodiments, the amount of nitrogen and/or nutrients that is added to the starting organic matter component is substantially reduced due to the level of available nitrogen and/or nutrients present in the organic matter component. In some embodiments, the level of available nitrogen in the organic matter component is high enough such that no additional nitrogen is required and thus the amount of the nitrogen component is reduced to zero. In some embodiments, the level of available nutrients in the organic matter component is high enough such that no additional nutrients are required and thus the amount of the nutrients component is reduced to zero. As one of ordinary skill in the art will appreciate, a lower amount of added commercially-prepared nitrogen and/or nutrients will reduce the overall carbon footprint of the fertilizer product as less commercially-prepared chemicals will be required during processing. Because there will be less reliance upon commercially- or factory-produced chemicals, there will be less greenhouse gases spent and/or produced by factories in order to produce the fertilizer products disclosed herein. Therefore, fewer commercially-prepared chemicals will leach from the fertilizer product into the soils and the ground water. Additionally, less commercially-prepared nutrients including, without limitation, phosphorus, potassium, calcium, magnesium, sulfur, silicon, chlorine, iron, boron, manganese, sodium, zinc, copper, nickel, molybdenum, selenium, aluminum, cobalt, and less commercially-prepared nitrogen products such as ammonia, ammonium, and similar products, will leach into the ground water where they may be carried with evaporated water into the atmosphere. Each of these aspects help to reduce the overall carbon footprint of the disclosed fertilizer products.

The moisture content of the low-carbon fertilizers can vary. In some embodiments, the moisture content of the low-carbon fertilizers, as a percent of the total weight of the fertilizer, is selected from greater than 1%, greater than 2%, greater than 3%, greater than 4%, greater than 5%, greater than 6%, greater than 7%, greater than 8%, greater than 9%, greater than 10%, greater than 11%, greater than 12%, greater than 13%, greater than 14%, greater than 15%, greater than 16%, greater than 17%, greater than 18% and greater than 19%. In some embodiments, the moisture content of the low-carbon fertilizers, as a percent of the total weight of the fertilizer, is selected from less than 20%, less than 19%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, and less than 1%. In some embodiments, the moisture content of the low-carbon fertilizers is 15% of the total weight of the fertilizers. In some embodiments, the moisture content of the low-carbon fertilizers is 17% of the total weight of the fertilizers. In some embodiments, the moisture content of the low-carbon fertilizers is 20% of the total weight of the fertilizers.

### Organic Matter

In various aspects, the low-carbon fertilizer comprises an organic matter component. The organic matter component may comprise any one or more of a variety of organic matter. In some embodiments, the organic matter component comprises raw manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, and combinations thereof.

In some embodiments, the organic matter component comprises raw plant matter, or other naturally occurring material such as, for example, bacteria, algae, fungi, coal, other mined material, or combinations thereof.

In some embodiments, the organic matter component comprises composted manure from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals, other animal sources, and combinations thereof.

In some embodiments, the organic matter component comprises composted plant matter.

In some embodiments, the organic matter component comprises ash produced in incineration facilities. In some embodiments, the ash produced in incinerator facilities is incinerator ash. In some embodiments, the ash produced in incinerator facilities is incinerator bottom ash. In some embodiments, the ash produced in incinerator facilities is incinerator fly ash. In some embodiments, the ash produced in incineration facilities is discharged from the moving grate of municipal solid waste incinerators. In some embodiments, this ash can be processed to remove contaminants prior to use as an organic matter component in the disclosed fertilizers. In some embodiments, the ash produced in incinerator facilities is boiler ash. In some embodiments, the ash produced in incinerator facilities is boiler wood ash. In some embodiments, the wood ash is the residue power remaining after the combustion of wood. In some embodiments, the ash produced in incinerator facilities is boiler coal ash. In some embodiments, the coal ash is the residue power remaining after the combustion of coal. In some embodiments, the coal ash is produced from burning coal for, for example, electrical power generation. In some embodiments, the coal ash is bottom ash that has accumulated at the bottom of the burner. In some embodiments, the coal ash is fly ash that is collected in a smoke stack scrubber. In some embodiments, the ash produced in incinerator facilities is boiler tire ash. In some embodiments, the tire ash is the residue power remaining after the combustion of tires. In some embodiments, the tire ash is from used tires that have been ground and burned for, for example, fuel.

In some embodiments, the organic matter component comprises gasifier ash. In some embodiments, the gasifier ash is produced by a gasification process and/or by a process that converts carbon-based materials (e.g. coal, petroleum, biofuels, house waste, compost, biomass, etc.) into carbon monoxide and hydrogen by reacting the materials with oxygen and/or steam at high temperatures. Such process typically occur within a gasifier. In a gasifier, the carbon-based material undergoes several different processes during the production of ash. Such processes include, for example: pyrolysis, which occurs as the carbon-based material heats up; combustion, which occurs as the volatile products and some of the charred carbon-based material reacts with oxygen to form carbon dioxide and carbon monoxide; and gasification, which occurs as the charred carbon-based material reacts with carbon dioxide and steam to produce carbon monoxide and hydrogen. What is left of the carbon-based starting material after these processes is ash. In some embodiments, the gasifier ash is produced by a counter-current fixed bed gasifier. In some embodiments, the gasifier ash is produced by a co-current fixed bed gasifier. In some embodiments, the gasifier ash is produced by a fluidized bed gasifier. In some embodiments, the gasifier ash is produced by an entrained flow gasifier.

In some embodiments, the organic matter component comprises food waste. In some embodiments, food waste comprises any food substance, raw or cooked, which is discarded, intended to be discarded, and/or required to be discarded. In countries that operate commercial and/or industrial agriculture, food waste can occur at many stages of the food industry, beginning at the very initial stages of food production and continuing through to post-consumer or diner food waste. For example, food waste can include crop and/or farm product waste from damaged or otherwise unusable crops, waste from machine harvesting, waste from selective harvesting, food processing waste, waste from food storage, food waste generated by safety regulations, retail packaging waste, restaurant waste, and any other type of food waste.

In some embodiments, the organic matter component comprises composted food waste. In some embodiments, composted food waste comprises any food substance, raw or cooked, which is discarded, intended to be discarded, and/or required to be discarded.

In some embodiments, the organic matter component comprises fish waste. In some embodiments, the fish waste comprises fish manure. In some embodiments, the fish waste comprises fish heads, bones, fins, tails, skins, and combinations thereof. In some embodiments, the fish waste comprises organs, blood vessels, fat, and other products from the fish cleaning process.

In some embodiments, the organic matter component comprises composted fish waste. In some embodiments, the composted fish waste comprises fish manure. In some embodiments, the composted fish waste comprises fish heads, bones, fins, tails, skins, and combinations thereof. In some embodiments, the composted fish waste comprises organs, blood vessels, fat, and other products from the fish cleaning process.

In some embodiments, the organic matter component comprises digestates. In some embodiments, the digestates comprise any solid material remaining after anaerobic digestion of a biodegradable feedstock. Anaerobic digestion is a series of biological processes in which microorganisms break down biodegradable material in the absence of oxygen. In some embodiments, the digestates are acidogenic digestates. Acidogenic digestates are typically fibrous and consist of structural plant matter including, for example, lignin and cellulose; such digestates may also contain bacterial remnants and minerals. Acidogenic digestates typically have strong moisture retention properties. In some embodiments, the digestates are methanogenic digestates. Methanogenic digestates are typically liquid and are high in nitrates and phosphates.

In various aspects, the organic matter component comprises composted matter. Composting is the purposeful biodegradation of organic matter typically performed by microorganisms such as bacteria, yeasts and fungi. In low temperature phases of composting, a number of macroorganisms, such as ants, nematodes, isopods, earthworms, flies and gnats may also contribute to the composting process. The organic matter is metabolized by the micro- or macroorganisms and is either incorporated into the organisms themselves, or converted into a material commonly known as humus.

In some embodiments, hot, thermophilic composting is used to produce the composted organic matter components. In some embodiments, the composting is conducted by producing a plurality of piles of the organic matter, allowing the plurality of piles to become colonized with one or more micro- and/or macroorganisms, and allowing the one or more micro- and/or macroorganisms to biodegrade the organic matter. The composting conditions can be varied. For example, the size of the organic matter is a factor in determining compo stability, and, in some embodiments, mechanical particle size reduction of the starting organic matter can increase the speed of the composting process. Large pieces of plant matter, such as hardwood, may not be compostable in large sizes, whereas sawdust of the same type of wood may be readily compostable.

In various aspects, the organic matter is composted via a hot, thermophilic composting process. The hot, thermophilic composting process is hot because of the exothermic action of the thermophilic microorganisms decomposing the organic matter. The temperatures of a hot, thermophilic composting process can be sufficiently high to kill pathogens present in the composting organic matter. When the temperatures are sufficiently high, a sufficient number of pathogens are killed to allow the resulting compost to be safely used for agricultural and/or horticultural purposes.

The amount of the organic matter component in the low-carbon fertilizers can vary. In some embodiments, the amount of the organic matter component of the low-carbon fertilizers is selected from greater than 45%, greater than 46%, greater than 47%, greater than 48%, greater than 49%, greater than 50%, greater than 51%, greater than 52%, greater than 53%, greater than 54%, greater than 55%, greater than 56%, greater than 57%, greater than 58%, greater than 59%, greater than 60%, greater than 61%, greater than 62%, greater than 63%, greater than 64%, greater than 65%, greater than 66%, greater than 67%, greater than 68%, greater than 69%, greater than 70%, greater than 71%, greater than 72%, greater than 73%, greater than 74%, greater than 75%, greater than 76%, greater than 77%, greater than 78%, greater than 79%, greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, and greater than 99%. In some embodiments, the amount of the organic matter component of the low-carbon fertilizers is selected from less than 100%, less than 99%, less than 98%, less than 97%, less than 96%, less than 95%, less than 94%, less than 93%, less than 92%, less than 91%, less than 90%, less than 89%, less than 88%, less than 87%, less than 86%, less than 85%, less than 84%, less than 83%, less than 82%, less than 81%, less than 80%, less than 79%, less than 78%, less than 77%, less than 76%, less than 75%, less than 74%, less than 73%, less than 72%, less than 71%, less than 70%, less than 69%, less than 68%, less than 67%, less than 66%, less than 65%, less than 64%, less than 63%, less than 62%, less than 61%, less than 60%, less than 59%, less than 58%, less than 57%, less than 56%, less than 55%, less than 54%, less than 53%, less than 52%, less than 51%, less than 50%, less than 49%, less than 48%, less than 47%, less than 46%, and less than 45%.

### Biological Materials

In various aspects, the low-carbon fertilizer comprises a biological materials component. The biological materials component may comprise any one or more of a variety of biological materials. In some embodiments, the biological materials component is selected from bacteria, yeast, fungi, and combinations thereof. In some embodiments, the biological materials component is one or more bacteria. In some embodiments, the biological materials component comprises a nitrogen fixing bacteria. In some embodiments, the biological materials component is selected from diazotrophs, cyanobacteria, azotobacteraceae, rhizobia, frankia, azospirillum, Klebsiella pneumoniae, Azotobacter vinlandii, Desulfovibrio, Bacillus polymyxa, Bacillus macerans, Escherichia intermedia, Anabaena cylindrica and Nostoc commune, Plectonema, Rhodobacter sphaeroides, Rhodopseudomonas palustris, Rhodobacter capsulatus, and combinations thereof. In some embodiments, the biological materials component comprises an aerating bacteria that is capable of creating air pockets at or around plant roots.

Nitrogen fixation is a biological process by which atmospheric nitrogen (N₂) is converted into a form that is readily useable by one or more plants. Such forms of nitrogen can include, for example, ammonia and nitrogen dioxide. The biological process of nitrogen fixation occurs when atmospheric nitrogen is converted to a useable form of nitrogen by the enzyme nitrogenase.

The process of nitrogen fixation is essential for life as fixed nitrogen is required to synthesize the nitrogenous bases that comprise DNA and the amino acids that comprise peptides, polypeptides and proteins. Numerous prokaryotic organisms are capable of performing nitrogen fixation. Such bacteria can include, for example, bacteria, actinobacteria, and some anaerobic bacteria. Numerous strains and/or species of microorganisms are capable of performing nitrogen fixation. Such microorganisms can include, for example, diazotrophs, cyanobacteria, azotobacteraceae, rhizobia frankia, Klebsiella pneumoniae, Azotobacter vinlandii, Desulfovibrio, Bacillus polymyxa, Bacillus macerans, Escherichia intermedia, Anabaena cylindrica and Nostoc commune, Plectonema, Rhodobacter sphaeroides, Rhodopseudomonas palustris, Rhodobacter capsulatus, and others.

The amount of the biological materials component in the low-carbon fertilizers can vary. In some embodiments, the amount of the biological materials component of the low-carbon fertilizers is 0%. In some embodiments, the amount of the biological materials component of the low-carbon fertilizers is selected from greater than 0%, greater than 0.1%, greater than 0.2%, greater than 0.3%, greater than 0.4%, greater than 0.5%, greater than 0.6%, greater than 0.7%, greater than 0.8%, greater than 0.9%, greater than 1%, greater than 1.1%, greater than 1.2%, greater than 1.3%, greater than 1.4%, greater than 1.5%, greater than 1.6%, greater than 1.7%, greater than 1.8%, greater than 1.9%, and greater than 2%. In some embodiments, the amount of the biological materials component of the low-carbon fertilizers is selected from less than 2%, less than 1.9%, less than 1.8%, less than 1.7%, less than 1.6%, less than 1.5%, less than 1.4%, less than 1.3%, less than 1.2%, less than 1.1%, less than 1%, less than 0.9%, less than 0.8%, less than 0.7%, less than 0.6%, less than 0.5%, less than 0.4%, less than 0.3%, less than 0.2%, and less than 0.1%.

The moisture content of the low-carbon fertilizers, the temperatures achieved, and/or the pressures achieved during the processing of the low-carbon fertilizers can affect the biological materials. In some embodiments, the moisture content of the low-carbon fertilizers can affect the dormancy of dried biological materials. For example, granulated, dried, dormant biological materials can be added to the low-carbon fertilizers as described herein. In some embodiments, when the total moisture content of the low-carbon fertilizers exceeds approximately 20% of the total weight of the low-carbon fertilizer, the moisture will be sufficiently high to cause premature activation of the dormant biological materials. In some embodiments, the temperatures and/or pressures achieved during the processing of the low-carbon fertilizers can have a negative effect on the biological materials. For example, granulated, dried, dormant biological materials can be added to the low-carbon fertilizers as described herein. If the biological materials are added at a point during production of the low-carbon fertilizers where one or more subsequent temperatures and/or pressures will be high, such subsequent high temperatures and/or pressures may be sufficiently high to damage or kill the biological materials. Conversely, if the biological materials are added at a point during production of the low-carbon fertilizers where one or more subsequent temperatures and/or pressures are low, such subsequent low temperatures and/or pressures will not damage or kill the biological materials and the biological materials will be available to perform their desired biological functions in the final fertilizer product. Therefore, in some embodiments, the point at which the biological materials are added to the production line during the production of the low-carbon fertilizers can determine whether the biological materials will survive the production process. In some embodiments, the biological materials are sufficiently thermophilic so as to be able to survive the temperatures of the production processes described herein. In some embodiments, the biological materials are sufficiently hearty so as to be able to survive the pressures of the production processes described herein.

### Nutrients

In various aspects, the low-carbon fertilizer comprises a nutrients component. The nutrients component may comprise any one or more of a variety of nutrients. In some embodiments, the nutrients component comprises one or more chemicals that are necessary for plant growth. In some embodiments, the nutrients component comprises one or more chemicals that provide beneficial effects on plant growth. In some embodiments, the nutrients component comprises one or more chemicals that are necessary for plant growth and one or more chemicals that provide beneficial effects on plant growth. In some embodiments, the nutrients component comprises macronutrients. In some embodiments, the nutrients component comprises micronutrients. In some embodiments, the nutrients component comprises macronutrients and micronutrients. In some embodiments, the nutrients component is selected from phosphorus, potassium, calcium, magnesium, sulfur, silicon, chlorine, iron, boron, manganese, sodium, zinc, copper, nickel, molybdenum, selenium, aluminum, cobalt, and combinations thereof.

In some embodiments, the nutrients component comprises one or more chelated chemicals and/or one or more chemicals in a chelate complex. Chelated chemicals can include, for example, chelants, chelators, chelating agents, and/or sequestering agents. An example of a chelating agent is ethylenediaminetetraacetic acid. In some embodiments, the nutrients component comprises chelated iron.

The amount of the nutrients component in the low-carbon fertilizers can vary. In some embodiments, the amount of the nutrients component of the low-carbon fertilizers is 0%. In some embodiments, the amount of the nutrients component of the low-carbon fertilizers is selected from greater than 0%, greater than 0.1%, greater than 0.2%, greater than 0.3%, greater than 0.4%, greater than 0.5%, greater than 0.6%, greater than 0.7%, greater than 0.8%, greater than 0.9%, greater than 1%, greater than 1.1%, greater than 1.2%, greater than 1.3%, greater than 1.4%, greater than 1.5%, greater than 1.6%, greater than 1.7%, greater than 1.8%, greater than 1.9%, greater than 2%, greater than 3%, greater than 4%, greater than 5%, greater than 6%, greater than 7%, greater than 8%, greater than 9%, greater than 10%, greater than 11%, greater than 12%, greater than 13%, greater than 14%, greater than 15%, greater than 16%, greater than 17%, greater than 18%, greater than 19%, greater than 20%, greater than 21%, greater than 22%, greater than 23%, greater than 24%, greater than 25%, greater than 26%, greater than 27%, greater than 28%, greater than 29%, greater than 30%, greater than 31%, greater than 32%, greater than 33%, and greater than 34%. In some embodiments, the amount of the nutrients component of the low-carbon fertilizers is selected from less than 35%, less than 34%, less than 33%, less than 32% less than 31%, less than 30%, less than 29%, less than 28%, less than 27%, less than 26%, less than 25%, less than 24%, less than 23%, less than 22%, less than 21%, less than 20%, less than 19%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, less than 1.9%, less than 1.8%, less than 1.7%, less than 1.6%, less than 1.5%, less than 1.4%, less than 1.3%, less than 1.2%, less than 1.1%, less than 1%, less than 0.9%, less than 0.8%, less than 0.7%, less than 0.6%, less than 0.5%, less than 0.4%, less than 0.3%, less than 0.2%, and less than 0.1%.

### Nitrogen Source

In various aspects, the low-carbon fertilizer comprises a nitrogen source component. The nitrogen, source component may comprise any one or more of a variety of nitrogen sources. In some embodiments, the nitrogen source component comprises one or more chemicals that are necessary for plant growth. In some embodiments, the nitrogen source component comprises one or more chemicals that provide beneficial effects on plant growth. In some embodiments, the nitrogen source component comprises one or more chemicals that are necessary for plant growth and one or more chemicals that provide beneficial effects on plant growth. In some embodiments, the nitrogen source component is selected from ammonia, urea, ammonium nitrate, anhydrous ammonium nitrate, urea ammonium nitrate, sodium nitrate, other mined sources of nitrogen, and combinations thereof.

In some embodiments, the nitrogen source component raises the NPK level of the low-carbon fertilizers. Compound fertilizers, or NPK fertilizers, contain predominantly nitrogen, phosphorus, and potassium. It is advantageous to maintain a sufficient level of nitrogen, phosphorus and potassium in a fertilizer in order to provide a sufficient amount of these essential nutrients to a plant. Fertilizers with a high NPK value are thus competitive in the marketplace. Fossil fuel-based fertilizers having high NPK levels have the disadvantage of producing a higher carbon footprint, and are thus less environmentally friendly. However, it is difficult to add NPK to a fertilizer without adding a source of carbon, thus increasing the overall carbon footprint generated by the fertilizer production. The present disclosure addresses, and overcomes, this difficulty. In some embodiments, the nitrogen source component raises the NPK level of the low-carbon fertilizers without raising the carbon footprint.

The amount of the nitrogen source component in the low-carbon fertilizers can vary. In some embodiments, the amount of the nitrogen source component of the low-carbon fertilizers is 0%. In some embodiments, the amount of the nitrogen source component of the low-carbon fertilizers is selected from greater than 0%, greater than 1%, greater than 2%, greater than 3%, greater than 4%, greater than 5%, greater than 6%, greater than 7%, greater than 8%, greater than 9%, greater than 10%, greater than 11%, greater than 12%, greater than 13%, greater than 14%, greater than 15%, greater than 16%, greater than 17%, greater than 18%, greater than 19%, greater than 20%, greater than 21%, greater than 22%, greater than 23%, greater than 24%, greater than 25%, greater than 26%, greater than 27%, greater than 28%, greater than 29%, and greater than 30%. In some embodiments, the amount of the nitrogen source component of the low-carbon fertilizers is selected from less than 30%, less than 29%, less than 28%, less than 27%, less than 26%, less than 25%, less than 24%, less than 23%, less than 22%, less than 21%, less than 20%, less than 19%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2%, and less than 1%.

### Creation of the Low-Carbon Fertilizers

### Processes

The present disclosure provides processes that adapt fertilizer production processes to directly fabricate low-carbon fertilizers comprising at least one of an organic matter component, a biological materials component, a nutrients component, a nitrogen source component, and combinations thereof.

In various aspects, the low-carbon fertilizers disclosed herein are produced by processing a base of organic matter to include one or more biological materials, nutrients, nitrogen sources, and/or combinations thereof. In some aspects, the organic matter is processed to optimize moisture content and particle size and to remove contaminant material. In some embodiments, nutrients and a nitrogen source can be added during this processing of the organic matter. In some embodiments, the NPK ratio is adjusted during this processing of the organic matter. In various aspects, the optimized organic matter is processed further to a final particle size. In some embodiments, biological materials are added during this further processing of the organic matter. In various aspects, the processed low-carbon fertilizer is then packaged and/or stored, depending on the desired application and/or use.

In some aspects, the processes comprise: processing organic matter to optimize moisture content, optimize particle size and remove contaminants; adding one or more nutrients components and one or more nitrogen sources to the organic matter; processing the organic matter, which includes the nutrients component(s) and nitrogen source(s), to a final particle size; and adding one or more biological materials components to produce low-carbon fertilizers. In some embodiments, the processes also comprise packaging the low-carbon fertilizers. In some embodiments, the processes also comprise storing the low-carbon fertilizers.

In some aspects, the processes comprise: loading bulk organic matter into a load hopper; sizing the bulk organic matter in a single vibrating screen; adding one or more nutrients components and/or one or more nitrogen source components to the bulk organic matter in a batch mixer to form a mixture; passing the mixture to a feed hopper; passing the mixture to a pellet mill via a conveyor; generating pellets from the mixture in the pellet mill; cooling the pellets on a conveyor; sizing the pellets in a crumbler to created sized pellets; recovering the sized pellets in a double vibrating screen; and adding one or more biological material components to the sized pellets in a conveyor to generate low-carbon fertilizers.

In some aspects, the processes comprise: loading bulk organic matter into a feeder; drying the organic matter in an agitated tube dryer; sizing the bulk organic matter in a single vibrating screen; adding one or more nutrients components and/or one or more nitrogen source components to the bulk organic matter on a conveyor to form a mixture; passing the mixture to a pellet mill; generating pellets from the mixture in the pellet mill; passing the pellets to a cooler; cooling the pellets in the cooler; sizing the pellets in a crumbler to created sized pellets; recovering the sized pellets in a double vibrating screen; and adding one or more biological material components to the sized pellets in a conveyor to generate low-carbon fertilizers.

In some embodiments, the organic matter used as the starting material for the processes of the present disclosure may be pre-processed prior to inclusion into one or more of the disclosed processes. Such pre-processing can be performed for a variety of reasons including, for example, to remove refuse or other matter that may not be desirable for inclusion into one or more low-carbon fertilizers. In some embodiments, the pre-processing is performed to remove plastics, extruded polystyrene foam, and other, related non-organic matter. In some embodiments, the pre-processing is performed to remove potentially hazardous and/or toxic inorganic materials such as mercury, arsenic, cyanide and similar inorganic materials. In some embodiments, the pre-processing is performed to remove moisture. In some embodiments, the pre-processing is performed to remove any combination of the foregoing.

Unless otherwise indicated in the exemplary processes described below, the described conveyors can be of any type that are commercially available.

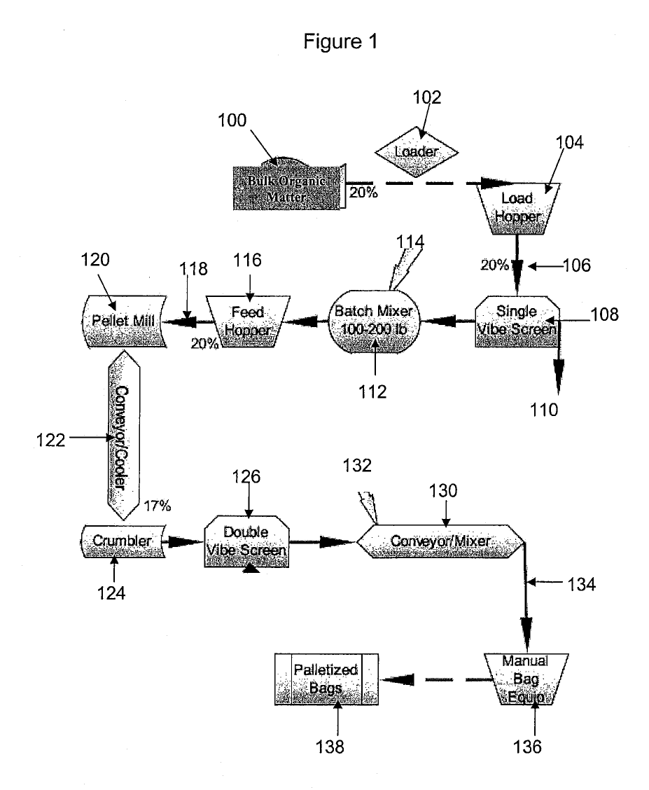

An exemplary process for producing the low-carbon fertilizers disclosed herein is depicted in FIG. 1. In the depicted process, bulk organic matter 100, which can comprise either raw or composted organic matter as described herein, is present in or near a facility housing the machinery used in the process. The bulk organic matter 100 contains approximately 20% moisture content prior to processing.

At the facility, the bulk organic matter 100 is loaded onto a loader 102 and placed into a load hopper 104 to initiate processing. In some embodiments, the loader 102 is a front end loader capable of transporting large amounts of the bulk organic matter to the load hopper 104. The loader 102 can be any type that is commercially available including, for example, a Caterpillar 226B Skid Steer (Peoria, Ill.). In an alternate embodiment, the bulk organic matter 100 may be placed into the load hopper 104 manually. The load hopper 104 can be any type that is commercially available including, for example, a Rapat F4218 Conveyor (Hawley, Minn.). The bulk organic matter 100, having a moisture content of approximately 20% of its total weight, is moved from the load hopper 104 to a single vibrating screen 108, via a conveyor belt 106. At the single vibrating screen 108, the bulk organic matter 100 is sized; oversized matter 110, too large to pass through the screen 108, is discarded. The screen 108 vibrates to help facilitate the sizing process and to ensure that all of the matter that is capable of passing through the screen is processed further. The screen 108 can be any type that is commercially available including, for example, the MR Series Separator (Midwestern Industries, Massillon, Ohio).

The single vibrating screen 108 can vary in mesh size. In some embodiments, the mesh size of the screen 108 is selected from greater than 0.1″, greater than 0.125″, greater than 0.2″, greater than 0.25″, greater than 0.3″, greater than 0.35″, greater than 0.4″, greater than 0.45″, and greater than 0.5″. In some embodiments, the mesh size of the screen 108 is selected from less than 0.5″, less than 0.45″, less than 0.4″, less than 0.35″, less than 0.3″, less than 0.25″, less than 0.2″, less than 0.125″, and less than 0.1″.

The material that successfully passes through the single vibrating screen 108 is then moved to a batch mixer 112. In some embodiments, the batch mixer 112 can have a capacity of approximately 100 pounds-200 pounds. The batch mixer 112 can be any type that is commercially available including, for example, a Kellandoplex 600 Feed Mill, serial number 57717 (Right Stuff Equipment, Commerce City, Colo.). At the batch mixer 112, the sized matter is mixed with any one or more additives 114. In some embodiments, the additives 114 comprise one or more nutrients components, one or more nitrogen source components, one or more biological materials, and/or combinations thereof. The additives 114 can be added manually or by any automated means including, for example, an automated metering dispenser. The additives 114 can be in any form. In some embodiments, the additives 114 are powdered and added to the sized organic matter in a dry state. In some embodiments, the additives 114 are liquid and added to the sized organic matter as a liquid. In some embodiments, one of the additives 114 is in a dry form and one of the additives 114 is in a liquid form. The sized organic matter and the additives 114 are mixed together in the batch mixer 112 for at least one minute. In some embodiments, the sized organic matter and the additives 114 are mixed together in the batch mixer for a period of time ranging from 1 to 20 minutes.

In various embodiments, the additives 114 comprise any one or more of the biological components disclosed herein that are thermophilic, or capable of withstanding the temperatures and/or pressures of the remaining steps of the exemplary process, and are powdered. In such embodiments, the biological components can be in any dry form including, for example, granulated or a dried cake, and are typically dormant or inactive.

Once the sized organic matter and the additives 114 are mixed, the resulting mixture is moved from the batch mixer 112 to a feed hopper 116 for delivery to a pellet mill 120. The resulting mixture can be moved from the batch mixer 112 to the feed hopper 116 manually, or by any number of mechanical means including, for example, by a conveyor. The feed hopper 116 can be any type that is commercially available including, for example, an Incline/Infeed Conveyor (Right Stuff Equipment, Commerce City, Colo.). At the feed hopper 116, the resulting mixture, which in the depicted embodiment comprises sized organic matter and additives 114, has a relative moisture content of approximately 20% of its total weight. From the feed hopper 116, the resulting mixture is delivered to a pellet mill 120 via a conveyor belt 118. The conveyor 118 continuously feeds the resulting mixture from the feed hopper 116 to the pellet mill 120 until the feed hopper 116 is empty.

At the pellet mill 120 the resulting mixture is formed into pellets. The pellet mill 120 converts the resulting mixture into pellets. The pellet mill 120 can be any type that is commercially available including, for example, ring die pellet mills, flat die pellet presses, inside out pellet mills, pancake pellet mills, and others. In some embodiments, the pellet mill 120 is a Pellet Pros model number PP2800 (Kewanee, Ill.). in some embodiments, the pellets are made by compacting the resulting mixture into and through small holes located in a die in the pellet mill 120. The pellet mill 120 combines small pieces of the resulting mixture into a plurality of larger, homogeneous pellets. In this way, the pellet mill 120 is similar to an extruder. The pellet mill 120 compacts the resulting mixture at temperature range of from about 100° F. to 160° F. and high pressure (up to 25,000 pounds per square inch at the die). In some embodiments, the pellet mill 120 converts the resulting mixture into pellets without adding any further components. In some embodiments, the pellet mill 120 converts the resulting mixture into pellets by adding steam to the resulting mixture.

The resulting pellets are moved from the pellet mill 120 to a crumbler 124 by way of a cooler/conveyor 122. In the depicted embodiment, the cooler/conveyor 122 is a long conveyor belt that has air blowing through and/or along at least a part of the length of its path. The air serves to cool the resulting pellets. The air may be blown through and/or along the length of the cooler/conveyor 122 by any means including, for example, by an air compressor or by one or more fans. The air blowing through and/or along the cooler/conveyor 122 also serves to dehydrate the resulting pellets. Upon reaching the end of the cooler/conveyor 122, the resulting pellets have a relative moisture content of approximately 17% of their total weight.

The cooler/conveyor 122 delivers the resulting pellets to a crumbler 124, where the resulting pellets are broken down to a target size. The crumbler 124 can be any type that is commercially available including, for example, 9×24 Rolling Mill by Harsh Denver (Eaton, Colo.). In various embodiments, the target size diameter of the crumbled pellets is selected from greater than 0.010″, greater than 0.025″, greater than 0.050″, greater than 0.1″, greater than 0.125″, greater than 0.2″, greater than 0.25″, greater than 0.3″, greater than 0.35″, greater than 0.4″, greater than 0.45″, and greater than 0.5″. In various embodiments, the target size diameter of the crumbled pellets is selected from less than 0.5″, less than 0.45″, less than 0.4″, less than 0.35″, less than 0.3″, less than 0.25″, less than 0.2″, less than 0.125″, less than 0.1″, less than 0.050″, less than 0.025″, and less than 0.010″. From the cooler/conveyor 122, the resulting pellets are feed into the crumbler 124, which comprises a plurality of rolls, each roll having an edge or a nip set to a specified size, and each roll turning in a single direction. The edge or nip on the rolls of the crumbler 124 serve to break the resulting pellets down to a target size.

From the crumbler 124, the resulting sized pellets are moved to a double vibrating screen 126. At the double vibrating screen 126, the resulting sized pellets are sorted for the proper size. The proper size pellets will fall through the first of the double screens, but not the second of the double screens, such that the second of the double screens 126 will collect pellets of the desired size. Pellets that are too large to pass through either of the double screens 126, are recycled to the crumbler 124 for re-sizing Pellets that are too small will pass through both of the double screens; these small pellets are recycled to the pellet mill 120 for further processing. The double screen 126 vibrates to help facilitate the sizing process and to ensure that all of the matter that is capable of passing through one or both of the screens is properly sized. The double vibrating screen 126 can be any type that is commercially available including, for example, an MEV High Frequency Screener (Midwestern Industries, Massillon, Ohio). The double vibrating screen 126 can vary in mesh size. In some embodiments, the mesh size of the collecting screen of the double screen 126 is selected from greater than 0.010″, greater than 0.025″, greater than 0.050″, greater than 0.1″, greater than 0.125″, greater than 0.2″, greater than 0.25″, greater than 0.3″, greater than 0.35″, greater than 0.4″, greater than 0.45″, and greater than 0.5″. In some embodiments, the mesh size of the collecting screen of the double screen 126 is selected from less than 0.5″, less than 0.45″, less than 0.4″, less than 0.35″, less than 0.3″, less than 0.25″, less than 0.2″, less than 0.125″, less than 0.1″, less than 0.050″, less than 0.025″, and less than 0.010″.

From the double vibrating screen 126, the properly sized pellets are moved to a conveyor/mixer 130. The conveyor/mixer 130 provides a sufficient amount of mechanical agitation to the pellets so that one or more additional components 132 can be added to the pellets while they are on the conveyor/mixer 130 and such components 132 will be mixed in with the pellets. The conveyor/mixer 130 can be any type that is commercially available including, for example, the Series 400 from Hapman (Kalamazoo, Mich.). In some embodiments, the additional components 132 comprise any one or more of the biological materials disclosed herein. The additional components 132 can be added manually or by any automated means including, for example, an automated metering dispenser. The additional components 132 can be in any form. In some embodiments, the additional components 132 are powdered and added to the pellets in a dry state. In some embodiments, the additional components 132 are powdered and serve to at least partially coat the pellets. In some embodiments, the additional components 132 are liquid and added to the pellets as a liquid. The pellets and the additional components 132 are mixed together on the conveyor/mixer 130 and are completely mixed upon reaching the end of the conveyor/mixer 130.

In various embodiments, the additives 114 and/or the additional components 132, as appropriate, comprise any one or more of the biological components disclosed herein and are powdered. In such embodiments, the biological components can be in any dry form including, for example, granulated or a dried cake, and are typically dormant or inactive. Upon the addition of a sufficient amount of moisture and/or upon reaching the proper temperature, the biological components become “active” in that they transform from a dormant state to an active, living form.

In the depicted embodiment, the resulting low-carbon fertilizer is moved from the conveyor/mixer 130 to a bagging station 136 via an output conveyor 134. At the bagging station 136, the low-carbon fertilizer can be bagged or stored, depending on the desired use of the fertilizer. In those embodiments where the low-carbon fertilizer is bagged, the bagged fertilizer can be placed in pallets 138 for shipping to consumers.

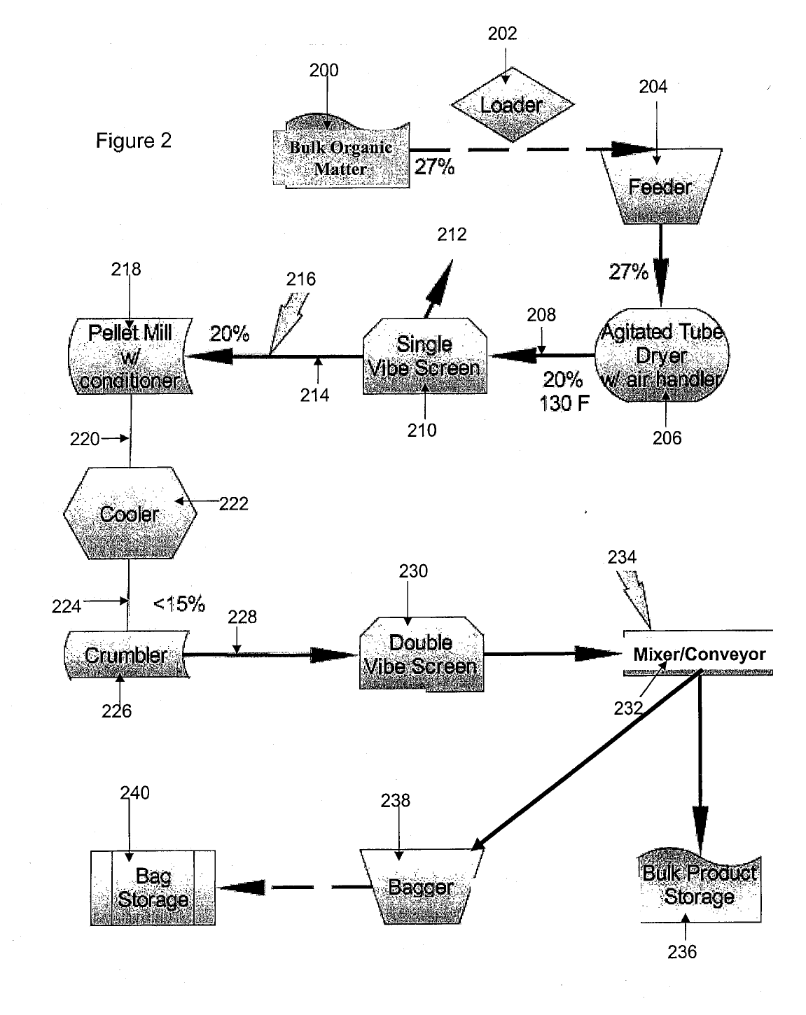

Another exemplary process for producing the low-carbon fertilizers disclosed herein is depicted in FIG. 2. In the depicted process, bulk organic matter 200, which can comprise either raw or composted organic matter as described herein, is present in or near a facility housing the machinery used in the process. The bulk organic matter 200 contains approximately 27% moisture content prior to processing.

At the facility, the bulk organic matter 200 is loaded onto a loader 202 and placed into a feeder 204 to initiate processing. In some embodiments, the loader 202 is a front end loader capable of transporting large amounts of the bulk organic matter to the feeder 204. The loader 202 can be any type that is commercially available including, for example, a Caterpillar 226B Skid Steer (Peoria, Ill.). In an alternate embodiment, the bulk organic matter 200 may be placed into the feeder 204 manually. The feeder 204 can be any type that is commercially available including, for example, a Model 601 Crumbler (Scott Equipment, New Prague, Minn.). The bulk organic matter 200, having a moisture content of approximately 27% of its total weight, is moved from the feeder 204 to an agitated tube dryer 206. In some embodiments, the dryer 206 comprises an air handler such that air is forced through the dryer 206. The agitated tube dryer 206 serves to break up the bulk organic matter 200 by mechanical agitation and to remove moisture by providing a heat source. The heat source may be of any type including, for example, a gas powered heat source, a forced air heater, and similar heat sources. In various embodiments, the agitated tube dryer 206 heats the bulk organic matter. In some embodiments, the dryer 206 heats the bulk organic matter to a temperature selected from greater than 100° F., greater than 115° F., greater than 120° F., greater than 125° F., greater than 130° F., greater than 135° F., greater than 140° F., greater than 145° F., and greater than 150° F. In some embodiments, the dryer 206 heats the bulk organic matter to a temperature selected from less then 150° F., less than 145° F., less than 140° F., less than 135° F., less than 130° F., less than 125° F., less than 120° F., less than 115° F., and less than 100° F. The agitated tube dryer 206 can be any type that is commercially available including, for example, a Model 2412AST agitated tube dryer (Scott Equipment, New Prague, Minn.).

The resulting organic matter, having a moisture content of approximately 20% of its total weight, is moved from the agitated tube dryer 206 to a single vibrating screen 210, via a conveyor belt 208. At the single vibrating screen 210, the resulting organic matter is sized; oversized matter 212, too large to pass through the screen 210, is discarded. The screen 210 vibrates to help facilitate the sizing process and to ensure that all of the matter that is capable of passing through the screen is processed further.

The single vibrating screen 210 can vary in mesh size. In some embodiments, the mesh size of the screen 210 is selected from greater than 0.1″, greater than 0.125″, greater than 0.2″, greater than 0.25″, greater than 0.3″, greater than 0.35″, greater than 0.4″, greater than 0.45″, and greater than 0.5″. In some embodiments, the mesh size of the screen 210 is selected from less than 0.5″, less than 0.45″, less than 0.4″, less than 0.35″, less than 0.3″, less than 0.25″, less than 0.2″, less than 0.125″, and less than 0.1″. The single vibrating screen 210 can be any type that is commercially available including, for example, a Rotex MWMM (Cincinnati, Ohio).

The material that successfully passes through the single vibrating screen 210 is then moved to a conveyor 214. At the conveyor 214, the sized material is mixed with one or more additives 216. The conveyor 214 mixes the sized material with the one or more additives 214 by mechanical agitation; the mechanical movement of the conveyor 214 serves to mix the sized material with the one or more additives 216. In some embodiments, the additives 216 comprise one or more nutrients components, one or more nitrogen source components, one or more biological materials, and/or combinations thereof. The additives 216 can be added manually or by any automated means including, for example, an automated metering dispenser. The additives 216 can be in any form. In some embodiments, the additives 216 are powdered and added to the sized organic matter in a dry state. In some embodiments, the additives 216 are liquid and added to the sized organic matter as a liquid. In some embodiments, one of the additives 216 is in a dry form and one of the additives 216 is in a liquid form. The sized organic matter and the additives 216 are mixed together during the period of time they are on the conveyor 214.

In various embodiments, the additives 216 comprise any one or more of the biological components disclosed herein that are thermophilic, or capable of withstanding the temperatures and/or pressures of the remaining steps of the exemplary process, and are powdered. In such embodiments, the biological components can be in any dry form including, for example, granulated or a dried cake, and are typically dormant or inactive.

The resulting mixture of the organic matter and the one or more additives 216, having a moisture content of approximately 20% of its total weight, is moved from the conveyor 214 to a pellet mill 218. The pellet mill 218 can be any type that is commercially available including, for example, ring die pellet mills, flat die pellet presses, inside out pellet mills, pancake pellet mills, and others. In some embodiments, the pellet mill 218 is a CPM Roskamp Model PM3016 (California Pellet Mill, Waterloo, Iowa). At the pellet mill 218 the resulting mixture is formed into pellets. The pellets are made by compacting the resulting mixture into and through small holes located in a die (not shown) in the pellet mill 218. The pellet mill 218 combines small pieces of the resulting mixture into a plurality of larger, homogeneous pellets. In this way, the pellet mill 218 is similar to an extruder. The pellet mill 218 compacts the resulting mixture at a temperature range of from about 100° F. to 160° F. and high pressure (up to 25,000 pounds per square inch at the die). In some embodiments, the pellet mill 218 converts the resulting mixture into pellets without adding any further components. In some embodiments, the pellet mill 218 converts the resulting mixture into pellets by adding steam to the resulting mixture.

The resulting pellets are moved from the pellet mill 218 to a cooler 222. The cooler 222 serves to cool the resulting pellets. The cooler 222 may cool the pellets by any number of means including, for example, by air cooling the resulting pellets, by refrigerating the resulting pellets, or by any other means. The cooler 222 also serves to dehydrate the resulting pellets. The cooler 222 can be any type that is commercially available including, for example, CPM Roskamp Model CC1419 (California Pellet Mill, Waterloo, Iowa). Upon leaving the cooler 222, the resulting pellets have a relative moisture content of less than approximately 15% of their total weight.

The cooler 222 delivers the resulting pellets to a crumbler 226 via a conveyor 224, where the resulting pellets are broken down to a target size. In various embodiments, the target size diameter of the crumbled pellets is selected from greater than 0.010″, greater than 0.025″, greater than 0.050″, greater than 0.1″, greater than 0.125″, greater than 0.2″, greater than 0.25″, greater than 0.3″, greater than 0.35″, greater than 0.4″, greater than 0.45″, and greater than 0.5″. In various embodiments, the target size diameter of the crumbled pellets is selected from less than 0.5″, less than 0.45″, less than 0.4″, less than 0.35″, less than 0.3″, less than 0.25″, less than 0.2″, less than 0.125″, less than 0.1″, less than 0.050″, less than 0.025″, and less than 0.010″. From the conveyor 224, the resulting pellets are fed into the crumbler 226, which comprises a plurality of rolls, each roll having an edge or a nip set to a specified size, and each roll turning in a single direction. The edge or nip on the rolls of the crumbler 226 serve to break the resulting pellets down to a target size. The crumbler 226 can be any type that is commercially available including, for example, 9×24 Rolling Mill by Harsh Denver (Eaton, Colo.).

From the crumbler 226, the resulting sized pellets are moved to a double vibrating screen 230 via a conveyor 228. At the double vibrating screen 230, the resulting sized pellets are sorted for the proper size. The proper size pellets will fall through the first of the double screens, but not the second of the double screens, such that the second of the double screens 230 will collect pellets of the desired size. Pellets that are too large to pass through either of the double screens 230, are recycled to the crumbler 226 for re-sizing. Pellets that are too small will pass through both of the double screens; these small pellets are recycled to the pellet mill 218 for further processing. The double screen 230 vibrates to help facilitate the sizing process and to ensure that all of the matter that is capable of passing through one or both of the screens is properly sized. The double vibrating screen 220 can be any type that is commercially available including, for example, a Rotex Model 322GP (Cincinnati, Ohio). The double vibrating screen 230 can vary in mesh size. In some embodiments, the mesh size of the collecting screen of the double screen 230 is selected from greater than 0.010″, greater than 0.025″, greater than 0.050″, greater than 0.1″, greater than 0.125″, greater than 0.2″, greater than 0.25″, greater than 0.3″, greater than 0.35″, greater than 0.4″, greater than 0.45″, and greater than 0.5″. In some embodiments, the mesh size of the collecting screen of the double screen 230 is selected from less than 0.5″, less than 0.45″, less than 0.4″, less than 0.35″, less than 0.3″, less than 0.25″, less than 0.2″, less than 0.125″, less than 0.1″, less than 0.050″, less than 0.025″, and less than 0.010″.

From the double vibrating screen 230, the properly sized pellets are moved to a conveyor/mixer 232. The conveyor/mixer 232 provides a sufficient amount of mechanical agitation to the pellets that additional components 234 can be added to the pellets and mixed in with the pellets. In some embodiments, the additional components 234 comprise any one or more of the biological materials disclosed herein. The additional components 234 can be added manually or by any automated means including, for example, an automated metering dispenser. The additional components 234 can be in any form. In some embodiments, the additional components 234 are powdered and added to the pellets in a dry state. In some embodiments, the additional components 234 are powdered and serve to at least partially coat the pellets. In some embodiments, the additional components 234 are liquid and added to the pellets as a liquid. The pellets and the additional components 234 are mixed together on the conveyor/mixer 232 and are completely mixed upon reaching the end of the conveyor/mixer 234.

In various embodiments, the additives 216 and/or the additional components 234, as appropriate, comprise any one or more of the biological components disclosed herein and are powdered. In such embodiments, the biological components can be in any dry form including, for example, granulated or a dried cake, and are typically dormant or inactive. Upon the addition of a sufficient amount of moisture and/or upon reaching the proper temperature, the biological components become “active” in that they transform from a dormant state to an active, living form.

In the depicted embodiment, the resulting low-carbon fertilizer is moved from the conveyor/mixer 232 to either a bulk storage facility 236 or to a bagging station 238 via an output conveyor. At these locations, the low-carbon fertilizer can be bagged or stored, respectively, depending on the desired use of the fertilizer. In those embodiments where the low-carbon fertilizer is bagged, the bagged fertilizer can be placed in pallets and stored in a bagged form 240 for shipping to consumers.

### EXAMPLES

The following examples describe in detail the preparation and properties of certain exemplary low-carbon fertilizers. It will be apparent to those skilled in the art that many modifications, both to materials and methods, may be practiced without departing from the scope of the disclosure.

### Example 1

### Production of a Low-Carbon Fertilizer

A 25 pound batch of low-carbon fertilizer was produced using the production process shown in FIG. 1 and described herein. The total moisture content of the low-carbon fertilizer, post-production, was approximately 17%. The low-carbon fertilizer comprised the following:

organic matter: 24 pounds, 12 ounces composted dairy cattle manure;

nutrients: 2 ounces chelated iron (Novozymes, Salem, Va.);

biological materials: 2 oz. azospirillum (Terramax, Cottage Grove, Minn.).

The nutrients were added to the sized organic matter at the batch mixer 112, as described herein. The biological materials were added to the sized resulting pellets at the conveyor/mixer 130 as described herein.

### Example 2

### Production of a Low-Carbon Fertilizer

A 25 pound batch of low-carbon fertilizer was produced using the production process shown in FIG. 2 and described herein. The total moisture content of the low-carbon fertilizer, post-production, was less than approximately 15%. The low-carbon fertilizer comprised the following:

organic matter: 24 pounds, 12 ounces composted dairy cattle manure;

nutrients: 2 ounces chelated iron (Novozymes, Salem, Va.);

biological materials: 2 oz. azospirillum (Terramax, Cottage Grove, Minn.).

The nutrients were added to the sized organic matter at the conveyor 214, as described herein. The biological materials were added to the sized resulting pellets at the conveyor/mixer 232 as described herein.

### Example 3

### Production of a Low-Carbon Fertilizer

A 25 pound batch of low-carbon fertilizer was produced using the production process shown in FIG. 1 and described herein. The total moisture content of the low-carbon fertilizer, post-production, was approximately 17%. The low-carbon fertilizer comprised the following:

organic matter: 16 pounds, 12 ounces composted dairy cattle manure;

nutrients: 2 ounces chelated iron (Novozymes, Salem, Va.);

biological materials: 2 oz. azospirillum (Terramax, Cottage Grove, Minn.);

nitrogen source: 8 pounds urea (Frontier Fertilizer, Johnstown, Colo.).

The nutrients and nitrogen source were added to the sized organic matter at the batch mixer 112, as described herein. The biological materials were added to the sized resulting pellets at the conveyor/mixer 130 as described herein.

### Example 4

### Production of a Low-Carbon Fertilizer

A 25 pound batch of low-carbon fertilizer was produced using the production process shown in FIG. 2 and described herein. The total moisture content of the low-carbon fertilizer, post-production, was less than approximately 15%. The low-carbon fertilizer comprised the following:

organic matter: 16 pounds, 12 ounces composted dairy cattle manure;

nutrients: 2 ounces chelated iron (Novozymes, Salem, Va.);

biological materials: 2 oz. azospirillum (Terramax, Cottage Grove, Minn.);

nitrogen source: 8 pounds urea (Frontier Fertilizer, Johnstown, Colo.).

The nutrients and nitrogen source were added to the sized organic matter at the conveyor 214, as described herein. The biological materials were added to the sized resulting pellets at the conveyor/mixer 232 as described herein.

### Example 5

### Production of a Low-Carbon Fertilizer

A 25 pound batch of low-carbon fertilizer was produced using the production process shown in FIG. 2 and described herein. The total moisture content of the low-carbon fertilizer, post-production, was less than approximately 15%. The low-carbon fertilizer comprised the following:

organic matter: 8 pounds, 6 ounces composted dairy cattle manure;
8 pounds, 6 ounces gasifier ash (REM Engineering, Roswell, Ga.);

nutrients: 2 ounces chelated iron (Novozymes, Salem, Va.);

biological materials: 2 oz. azospirillum (Terramax, Cottage Grove, Minn.);

nitrogen source: 8 pounds urea (Frontier Fertilizer, Johnstown, Colo.).

The nutrients and nitrogen source were added to the sized organic matter at the conveyor 214, as described herein. The biological materials were added to the sized resulting pellets at the conveyor/mixer 232 as described herein.

From the above description of the disclosure, those skilled in the art will perceive improvements, changes and modifications. Such improvements, changes and modifications within the skill of the art are regarded as covered by the appended claims directly or as equivalents.

1-45. (canceled)

46. A fertilizer, comprising:
greater than 70% to less than 100% of an organic matter component;
greater than 0% to less than 30% of a biological materials component; and
greater than 0% to less than 30% of a nutrients component.

47. The fertilizer of claim 46, comprising greater than 0% to less than 30% of a nitrogen source component.

48. The fertilizer of claim 46 wherein the total moisture content of the fertilizer is selected from less than approximately 15% and approximately 17%.

49. The fertilizer of claim 46, wherein the organic matter component is manure from an animal selected from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals and combinations thereof; and
wherein the manure is selected from raw manure and composted manure.

50. The fertilizer of claim 46, wherein the organic matter component is selected from raw plant matter, composted plant matter, bacteria, algae, fungi, coal, and combinations thereof.

51. The fertilizer of claim 46, wherein the organic matter component comprises incinerator ash.

52. The fertilizer of claim 46, wherein the organic matter component comprises boiler ash.

53. The fertilizer of claim 46, wherein the organic matter component comprises gasifier ash.

54. The fertilizer of claim 46, wherein the organic matter component comprises fish waste.

55. The fertilizer of claim 46, wherein the organic matter component comprises composted fish waste.

56. The fertilizer of claim 46, wherein the organic matter component comprises a digestate selected from acidogenic digestates, methanogenic digestates, and combinations thereof.

57. The fertilizer of claim 46, wherein the biological matter component is selected from diazotrophs, cyanobacteria, azotobacteraceae, rhizobia, frankia, azospirillum, Klebsiella pneumoniae, Azotobacter vinlandii, Desulfovibrio, Bacillus polymyxa, Bacillus macerans, Escherichia intermedia, Anabaena cylindrica, Nostoc commune, Plectonema, Rhodobacter sphaeroides, Rhodopseudomonas palustris, Rhodobacter capsulatus, and combinations thereof.

58. The fertilizer of claim 46, wherein the nutrients component is selected from phosphorus, potassium, calcium, magnesium, sulfur, silicon, chlorine, iron, boron, manganese, sodium, zinc, copper, nickel, molybdenum, selenium, aluminum, cobalt, and combinations thereof.

59. The fertilizer of claim 47, wherein the nitrogen source component is selected from ammonia, urea, ammonium nitrate, anhydrous ammonium nitrate, sodium nitrate, mined sources of nitrogen, and combinations thereof.

60. A process for producing low-carbon fertilizers, comprising:
loading bulk organic matter into a load hopper;
sizing the bulk organic matter in a single vibrating screen;
adding a member of the group selected from nutrients and a nitrogen source to the bulk organic matter in a batch mixer to form a mixture;
passing the mixture to a feed hopper;
passing the mixture to a pellet mill via a conveyor;
generating pellets from the mixture in the pellet mill;
cooling the pellets on a conveyor;
sizing the pellets in a crumbler to created sized pellets;
recovering the sized pellets in a double vibrating screen; and
adding at least one biological material to the sized pellets in a conveyor to generate a low-carbon fertilizer.

61. The process of claim 60, wherein the organic matter is selected from:
raw manure from an animal selected from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals and combinations thereof;
raw plant matter, bacteria, algae, fungi, coal, and combinations thereof;
composted manure from an animal selected from dairy cattle, non-dairy cattle, bison, buffalo, other bovine species, chickens, turkeys, other poultry species, ostriches, sheep, other ovine species, pigs, hogs, other porcine species, horses, mules, other equine species, llamas, humans, domestic animals, zoo animals and combinations thereof;
composted plant matter;
incinerator ash;
boiler ash;
gasifier ash;
a food substance selected from a raw food substance and a cooked food substance;
a composted food substance selected from a raw food substance and a cooked food substance;
fish waste;
composted fish waste; and
a digestate selected from acidogenic digestates, methanogenic digestates, and combinations thereof.

62. The process of claim 60, wherein the biological material is selected from diazotrophs, cyanobacteria, azotobacteraceae, rhizobia, frankia, azospirillum, Klebsiella pneumoniae, Azotobacter vinlandii, Desulfovibrio, Bacillus polymyxa, Bacillus macerans, Escherichia intermedia, Anabaena cylindrica, Nostoc commune, Plectonema, Rhodobacter sphaeroides, Rhodopseudomonas palustris, Rhodobacter capsulatus, and combinations thereof.

63. The process of claim 60, wherein the nutrients are selected from phosphorus, potassium, calcium, magnesium, sulfur, silicon, chlorine, iron, boron, manganese, sodium, zinc, copper, nickel, molybdenum, selenium, aluminum, cobalt, and combinations thereof.

64. The process of claim 60, wherein the nitrogen source is selected from ammonia, urea, ammonium nitrate, anhydrous ammonium nitrate, urea ammonium nitrate, sodium nitrate, mined sources of nitrogen, and combinations thereof.

65. A process for producing low-carbon fertilizers, comprising:
loading bulk organic matter into a feeder;
drying the organic matter in an agitated tube dryer;
sizing the bulk organic matter in a single vibrating screen;
adding a member of the group selected from nutrients and a nitrogen source to the bulk organic matter on a conveyor to form a mixture;
passing the mixture to a pellet mill;
generating pellets from the mixture in the pellet mill;
passing the pellets to a cooler;
cooling the pellets in the cooler;
sizing the pellets in a crumbler to created sized pellets;
recovering the sized pellets in a double vibrating screen; and
adding at least one biological material to the sized pellets in a conveyor to generate a low-carbon fertilizer.
